(19) United States
(12) Patent Application Publication
(10) Pub. No.: US 2009/0160634 A1
(43) Pub. Date: Jun. 25, 2009

(54) System and method for terminal truck management

(75) Inventors: Christopher James Alsop, Huntington Beach, CA (US); Thomas James Rucker, Seattle, WA (US); Donald H. Taylor, Seattle, WA (US); Bruce Kevin Kuenzi, Seattle, WA (US)

Correspondence Address: DORSEY & WHITNEY LLP;INTELLECTUAL PROPERTY DEPARTMENT, SUITE 3400, 1420 FIFTH AVENUE, SEATTLE, WA, 98101, US

(73) Assignee: Tideworks Technology, Inc.

(21) Appl. No.: 12/005,006

(22) Filed: Dec. 21, 2007

(51) Int. Cl. G08B 23/00; G08B 5/00

(52) U.S. Cl. 340/500; 340/815.4; 340/286.01; 345/1.1

(57) ABSTRACT

A system for management of port terminal operations is disclosed as one of the embodiments of the invention. The system includes a plurality of task communication devices, a plurality of first and second display devices, and a task dispatch system. Each of the task communication devices is associated with a respective one of a plurality of transportation equipment, and receives a signal indicative of at least one task to be completed by the associated transportation equipment. Each of the task communication devices has one of the first display devices and one of the second display devices coupled to it. Each first display device displays a first aspect of the at least one task. Each second display device displays a second aspect of the at least one task. The task dispatch system causes signals each of which indicative of at least one task to be completed by a respective one of the transportation equipment to be transmitted to the plurality of task communication devices.

### TECHNICAL FIELD

Embodiments of this invention relate to management of transportation equipment at a terminal, and more particularly, to providing visual display of a mission of freight container transportation equipment.

### BACKGROUND OF THE INVENTION

On an average day, a large number of freight containers are transported in and out of the seaports around the world. At each seaport, containers are loaded onto and unloaded from various types of transportation, such as container vessels, trains, and trucks, depending on the destination of each container. Consequently, operations that take place at a port terminal involve moving numerous containers from one location to another.

For example, when a cargo vessel is being loaded with containers in preparation to sail to another port, each of the containers to be loaded is first picked up at a storage area in the yard by a terminal truck, or a hustler, which queues up with other hustlers by the quay. The container is lifted off the hustler by a quay crane and loaded onto the vessel in a planned sequence. The sequence in which the containers are loaded is important because certain containers are destined for the first port the vessel will visit while other containers are destined for a subsequent port. In such case, the containers destined for the first port should be loaded onto the vessel last and those destined for the subsequent port should be loaded first. The relative weight of laden containers as well as other special stowage considerations may also affect the sequence of loading the vessel. The route of a hustler is also important to ensure an efficient operation. For instance, in the event that a hustler is to pick up a first container at a first location and a second container at a second location for loading onto a vessel, it is typically most efficient for the hustler to take the shortest route between its current location and the vessel such that the hustler can pick up the two containers in the correct order.

With various activities taking place and lots of containers being moved around in the terminal, issues such as hustler routing inefficiencies related to mixed cargo, improper queue sequence, driver latency and erroneous work instructions would impact the operation and thus need to be avoided as much as possible. One approach to avoid such issues is for supervisory personnel to rely on human communication via radio, placards, chalk markings on the containers themselves, oral messages, etc. In a communication method using placards, for example, placards are given to drivers of road trucks (or other types of transportation equipment) for display to viewers outside of the trucks. Placards are used to ensure that the correct container is placed on the road truck. The placard that each road truck receives may have, for example, a three-digit number that is associated with a particular move and identifies the respective truck to terminal equipment operators. This way, terminal equipment operators can more easily identify a particular truck and associate the identified truck with the move he is about to perform. Although this method works for delivery/receipt of containers to/from the road trucks, it is typically not employed for container movements performed by terminal trucks within the terminal. While the placard system is beneficial in associating an external truck with a particular container, the association is a static association that is only visible and meaningful to the operator of the terminal equipment that is performing the move; the placard does not provide detailed move information to personnel who are not assigned to the move.

Another approach that has been in use is for supervisory personnel to deliberately interrogate the workflow management system, if any, to access information related to an individual hustler's mission. However, due to the nature of their responsibilities, supervisory personnel may not have access or time to query the system through electronic means. As a result, situations such as hustlers queuing at the wrong container stack in the yard and/or delivering containers to the wrong area might occur; thereby resulting in poorly organized stacks of containers. These poorly organized stacks add unproductive moves to both export receiving and import delivery cycles, reducing terminal efficiency.

There is therefore a need for an improved system that notifies personnel in the operational area of the state and content of missions for terminal transportation equipment.

### BRIEF DESCRIPTION OF THE DRAWINGS

FIG. 1 illustrates a system for managing terminal transportation equipment in accordance with an embodiment of the invention.

FIG. 2 illustrates an example of information displayed on the transportation equipment in accordance with an embodiment of the invention.

FIG. 3A is a block diagram of the task communication system associated with each transportation equipment in accordance with an embodiment of the invention.

FIG. 3B is a block diagram of the task communication system associated with each transportation equipment in accordance with another embodiment of the invention.

FIG. 3C is a block diagram of the task communication system associated with each transportation equipment in accordance with yet another embodiment of the invention.

FIG. 4 is a schematic drawing of the roof of a transportation equipment's cab installed with display devices in accordance with an embodiment of the invention.

FIG. 5 is an exemplary screen shot of a mission received and displayed by a task communication device for container pickup at vessel in accordance with an embodiment of the invention.

FIG. 6 illustrates several examples of information displayed by display devices for the mission of container pickup at vessel in accordance with various embodiments of the invention.

FIG. 7 is an exemplary screen shot of a mission received and displayed by a task communication device for delivery of container from vessel to yard in accordance with an embodiment of the invention.

FIG. 8 illustrates information displayed by display devices for the mission of delivery of container from vessel to yard in accordance with an embodiment of the invention.

FIG. 9 is an exemplary screen shot of a mission received and displayed by a task communication device for pickup of a container being unloaded from rail (from a container train) in accordance with an embodiment of the invention.

FIG. 10 illustrates information displayed by display devices for the mission of container pickup at rail in accordance with an embodiment of the invention.

FIG. 11 is an exemplary screen shot of a mission received and displayed by a task communication device for delivery of container from rail to yard in accordance with an embodiment of the invention.

FIG. 12 illustrates three variations on information displayed by display devices for the mission of delivery of container from rail to yard in accordance with an different embodiments of the invention.

### DETAILED DESCRIPTION OF PREFERRED EMBODIMENTS

Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments.

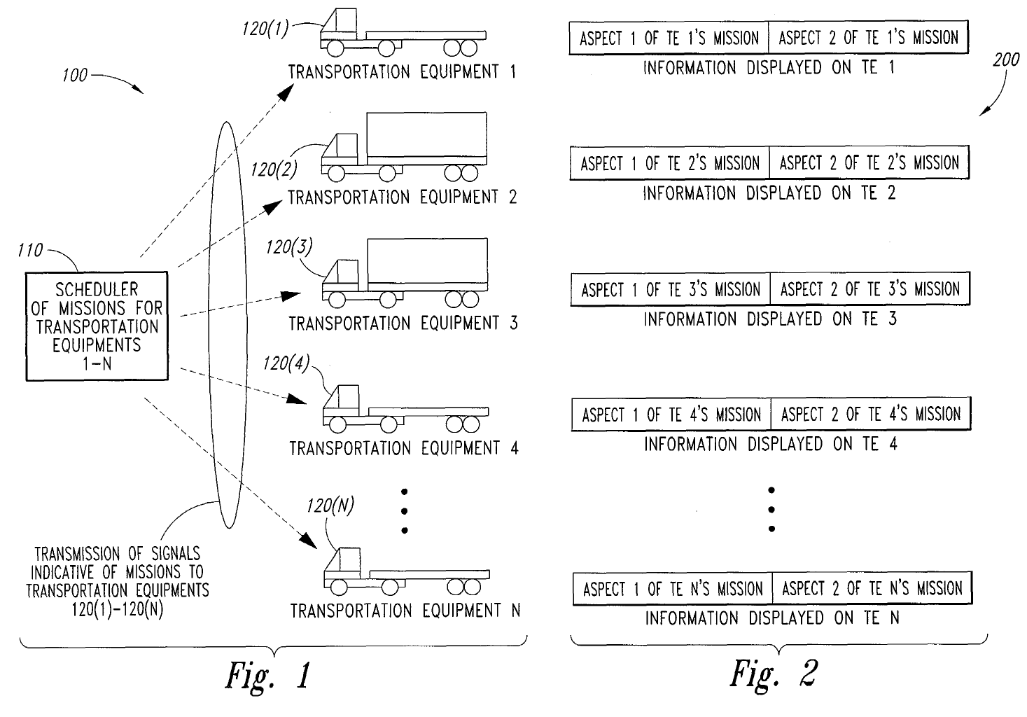

FIG. 1 illustrates a system 100 for managing terminal transportation equipment in accordance with an embodiment of the invention. The system includes a central communication system 110 and a number of transportation equipment 120(1)-120(N). The transportation equipment 120(1)-120(N) can represent different types of terminal equipment, such as a hustler, road truck, or any similar vehicle that facilitates movement of objects such as containers in a terminal. Each transportation equipment has an associated task communication system (not shown), which will be discussed in more detail later. The central communication system 110 is capable of scheduling missions for the transportation equipment 120(1)-120(N) and cause the missions to be dispatched to the transportation equipment 120(1)-120(N) by, for example, wireless communication. In one embodiment, the central communication system 110 may include a computer system (not shown) running a mission scheduling and dispatching software application (not shown), and may further include a transmitter to transmit mission information (e.g. via electromagnetic waves) indicative of the missions for the transportation equipment 120(1)-120(N). Alternatively, the central communication system 110 may include a dispatch system, such as a computer system running a mission dispatch software application, that receives the missions planned by another system and dispatches the missions to the transportation equipment 120(1)-120(N) over the wireless communication network.

Once the missions for the transportation equipment 120(1)-120(N) have been scheduled, the central communication system 110 transmits mission information to the respective task communication systems associated with the transportation equipment 120(1)-120(N). The mission information may be transmitted in a batch fashion, in one embodiment, or on a real-time basis, in another embodiment. More specifically, the central communication system 110 may dispatch missions to some or all of the transportation equipment 120(1)-120(N) after those missions have been scheduled. Alternatively, the central communication system 110 may dispatch missions to the transportation equipment 120(1)-120(N) in real-time. For example, as soon as a mission for one of the transportation equipment 120(1)-120(N) is known and scheduled, the mission information for that mission is transmitted to the assigned transportation equipment. For example, the central communication system 110 may have a list of missions scheduled for transportation equipment 120(1). The central communication system 110 can then either transmit mission information for all the scheduled missions to transportation equipment 120(1) or transmit mission information for the scheduled missions to the transportation equipment 120(1) one at a time such that the mission information for the next mission is transmitted when the previous mission has been completed.

Each of the missions scheduled for the transportation equipment 120(1)-120(N) may be composed of one or more various tasks. For example, for a vessel discharge mission, the respective transportation equipment 120(1)-120(N) assigned this mission will need to execute at least two tasks, namely: pickup at vessel (first task) and delivery to yard (second task). More specifically, to accomplish the first task, the respective transportation equipment assigned the vessel discharge mission will need to first queue up to pick up a container from the quay crane that is offloading the vessel. Once the respective transportation equipment completes the first task, it will need to deliver the container to a destination in the yard to offload the container for storage or further disposition, thus completing the second task. Furthermore, each task of a mission may have one or more aspects to it. For example, for the first task of pickup at vessel in the example above, one aspect of the task may be the crane number of the quay crane while another aspect of the task may be the sequence number with respect to vessel discharge.

In one embodiment, the central communication system 110 detects completion of a task of a mission by each of the transportation equipment 120(1)-120(N) by a triggering event relevant to the specific task being completed by the respective transportation equipment 120(1)-120(N). In another embodiment, the central communication system 110 detects completion of a task by each of the transportation equipment 120(1)-120(N) by a combination of a triggering event relevant to the specific task being completed by the respective transportation equipment and an indication that the respective transportation equipment is geographically located in an area associated with completion of the task. The triggering event to be detected as indication of completion of a task is specific to the task being completed. For instance, for a task that involves a transportation equipment picking up a container from a vessel, the release of the twistlock, a locking mechanism securing a container to a spreader bar used to transfer the container from the vessel to the transportation equipment by a quay crane, could be the triggering event because the twistlock's release suggests that a container has successfully been placed on the transportation equipment. This information, coupled with an indication that the particular transportation equipment assigned to complete this task is located in the vicinity of the quay crane (e.g., by the use of differential global positioning system, or DGPS), will provide strong indication that the particular transportation equipment has completed the task of picking up the container from the vessel, which the quay crane is offloading.

As shown in FIG. 1, some of the transportation equipment 120(1)-120(N) are shown to be carrying a load of a container and some have none. This is to illustrate the point that missions may be dispatched, or mission information may be transmitted, regardless of the type of mission, if any, being carried out by each individual transportation equipment at the time of dispatch. As described previously, missions may be dispatched in a real-time fashion or in a batch fashion. A transportation equipment may receive its next mission when it is carrying a container while another transportation equipment may receive its next mission when it is not carrying a container, whatever the case may be.

In one embodiment, the task communication system associated with each transportation equipment receives only those missions for the respective transportation equipment. This can be achieved by, for example, each task communication device having its own unique address on the wireless communication network and sending mission information using the corresponding address. In this embodiment, each task communication system only receives the mission information destined for the associated transportation equipment. In an alternative embodiment, each task communication system may be able to receive all the mission information but only allow the pertinent missions, such as those destined for the associated transportation equipment, to be displayed.

FIG. 2 illustrates a diagram 200 of example information displayed on the transportation equipment 120(1)-120(N) in accordance with an embodiment of the invention. In the present example, multiple aspects of a task of a mission can be displayed on each of the transportation equipment 120(1)-120(N), concurrently. In the case that the task being carried out has only one aspect to be displayed, only that one aspect will be displayed. For example, for a task that requires a hustler to pick up a particular container from a cargo train, the information displayed to the hustler operator by the associated task communication system may be limited to the container number of the particular container being picked up by the hustler. In the case that the task being carried out has more than one aspect to be displayed, two or more of the aspects of the mission will be displayed. For example, for a task that requires a hustler to deliver a container to a vessel for a loadback operation (i.e. loading containers onto the vessel), which involves a particular quay crane transporting the container from the hustler to the vessel, the information displayed on that hustler may have three aspects for display. The displayed information may include the number of the crane (as there may be several quay cranes at the terminal), the sequence number (as quay cranes load containers in a particular planned sequence), and the container number. As shown, embodiments of the invention provide flexibility in displaying pertinent information in order to put personnel in the terminal on notice of the respective mission tasks being carried out by the transportation equipment 120(1)-120(N).

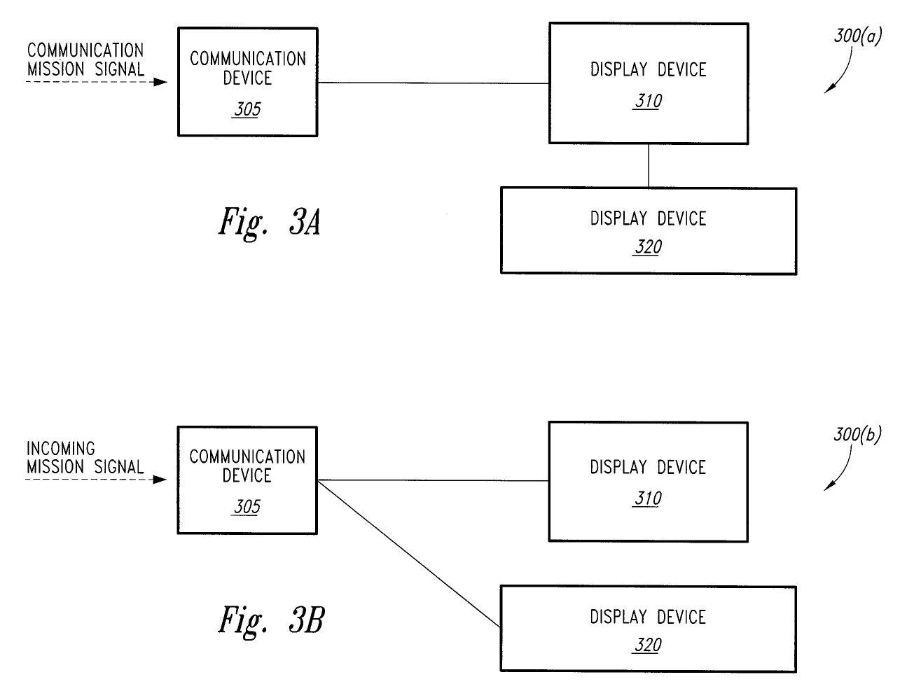

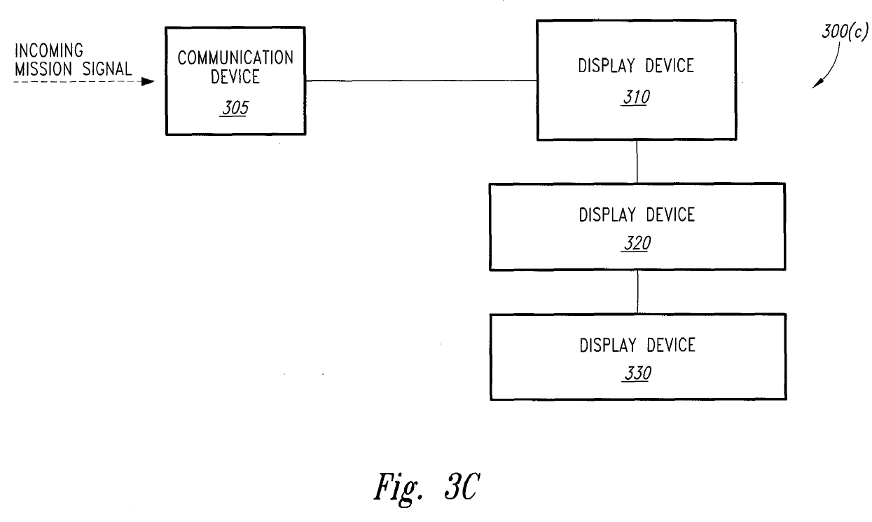

FIG. 3A illustrates a block diagram of a task communication system 300(a) associated with each transportation equipment in accordance with an embodiment of the invention. In the embodiment shown, the task communication system 300(a) includes communication device 305, display device 310, and display device 320. As mentioned previously, the communication device 305 is capable of receiving at least mission information for those missions dispatched for the associated transportation equipment. The display devices 310, 320 are coupled to the communication device 305 such that one of the display devices 310, 320 is coupled directly to the communication device 305 while the other one of the display devices 310, 320 is coupled to the communication device 305 through it, as shown in FIG. 3A. Each of the display devices 310, 320 may display the same or different aspects of a respective mission task. Each of the display devices 310, 320 is positioned on the associated transportation equipment so that each faces a different angle from the perspective of the associated transportation equipment. Accordingly, personnel in the terminal looking at the associated transportation equipment from different viewing angles can learn of at least one aspect of the mission being carried out, if displayed. For example, display device 310 may be top-facing for crane operators to see an aspect of the respective mission task (if the task is related to crane operation, such as delivering a container to a vessel) and display device 320 may be side-facing for operations on the ground to see the same or different aspect of the respective mission task.

FIG. 3B illustrates a task communication system 300(b) associated with each transportation equipment in accordance with another embodiment of the invention. In this embodiment, the display devices 310, 320 are each coupled to the communication device 305 directly.

FIG. 3C illustrates a task communication system 300(c) associated with each transportation equipment in accordance with yet another embodiment of the invention. In this embodiment, there are three display devices 310, 320, 330 coupled to the communication device 305. Although a daisy-chain connection is shown in FIG. 3C, alternative ways of connecting the display devices 310, 320, 330 to the communication device 305 are also possible. In addition, while at most three display devices are shown, embodiments of the invention are not limited to two or three display devices, and may include only one display device or more than three display devices. When there is more than one display device in use, each of the display devices may be positioned on the associated transportation equipment to face a certain angle to achieve desired visibility for the information displayed.

As shown in FIGS. 3A-3C, whether there are two, three, or more display devices, the display devices need not be in the same shape or size. The physical dimensions of each display device and the number of alphanumeric characters that can be displayed on the display device can be different from those of another display device. In one embodiment, display device 320, 330 can display a maximum number of alphanumeric characters at any one time, and if the alphanumeric characters in a message to be displayed exceed the maximum number allowable, the display of the message on display devices 320, 330 may scroll. In one embodiment, display device 310 may be used to display messages to crane operators and can display three alphanumeric characters at any one time. For example, display device 310 may display a three-digit number, such as a sequence number for the associated hustler carrying out a mission for loadback (putting containers on a vessel).

The task communication system shown in each of FIGS. 3A-3C is associated with a transportation equipment, such as one of the transportation equipment 120(1)-120(N). In one embodiment, the communication device 305 may be affixed in a location within the driver cab of a transportation equipment, for example the dashboard, in order for the driver to see information displayed on the communication device 305. The display devices 310, 320, 330 can be mounted exterior to the cab to allow the information displayed on the display devices 310, 320, 330 to be viewed from different angles. For example, some or all of the display devices 310, 320, 330 may be mounted on the top of the cab, hood, or elsewhere on the transportation equipment. In other embodiments, one or more of the display devices 310, 320, 330 can be located within the driver cab, but positioned so that the information displayed on the display devices 310, 320, 330 can be viewed through a window or opening in the cab.

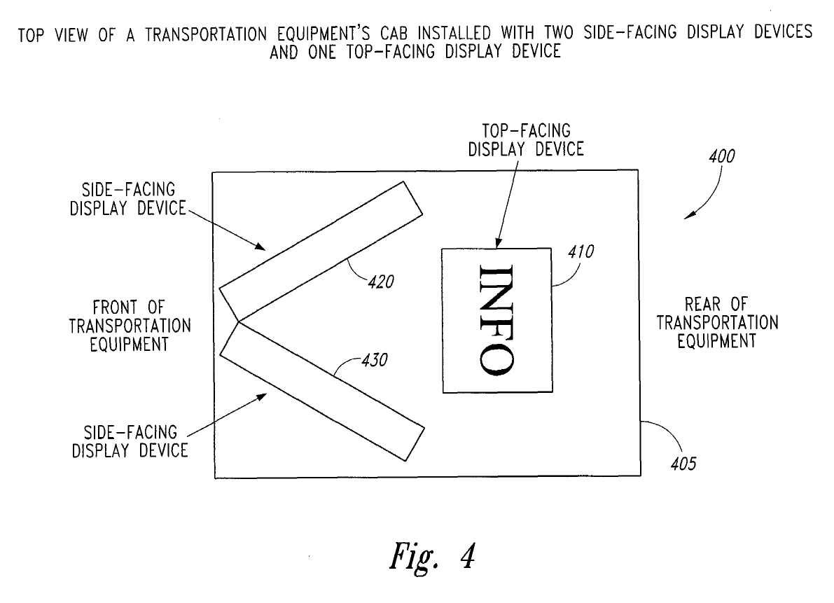

FIG. 4 illustrates an arrangement of display devices positioned on the roof 400 of a transportation equipment's cab in accordance with an embodiment of the invention. As shown in FIG. 4, one or more of the transportation equipment 120(1)-120(N) may have three display devices mounted on the roof 400 of the cab that houses the driver/operator of the transportation equipment. In an embodiment, the display devices may be light-emitting diode (LED) displays in which each pixel of the display area comprises of one or more LED device. In one embodiment, the size of characters and numbers displayed on the LED screens and the brightness of the display are such that the information displayed on the LED screens are visible from a distance of 150 feet under all weather conditions. In alternative embodiments, each of the display devices may use other electronic display technologies.

As shown in FIG. 4, display devices 420, 430 are side-facing and display device 410 is top-facing. The display devices 420, 430 are placed in such a way that each of them is visible from the front and generally from one side of the transportation equipment. In other words, the display devices 420, 430 face sideways from the cab at angles toward the front. The display device 410 faces up and provides information to crane operators while the side-facing display devices 420, 430 provide information to operators of lifting equipment and terminal personnel on the ground, for example.

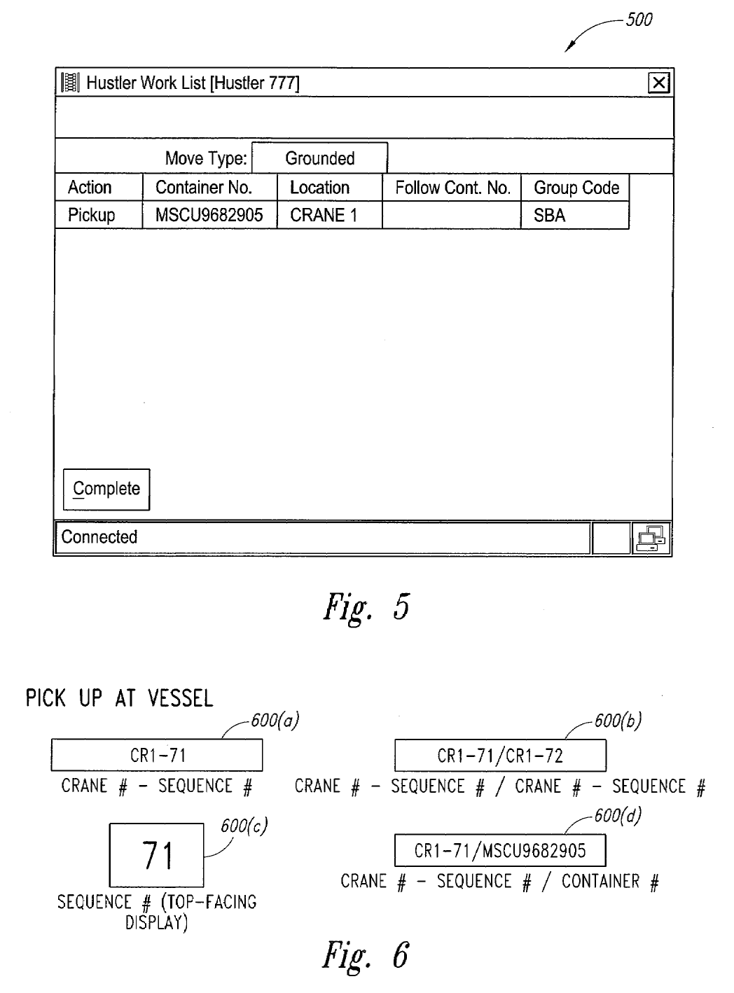

FIGS. 5-8 together depict the missions dispatched and information displayed in a vessel discharge scenario according to an embodiment of the invention. Typically, for vessel discharge, a hustler assigned to the vessel discharge mission is to pick up a container from the vessel and deliver the container to a location in the yard for storage or further disposition. In FIG. 5, a sample screen shot 500 of a mission task received and displayed by a task communication device for container pickup at vessel in accordance with an embodiment of the invention is shown. More specifically, FIG. 5 shows what a hustler driver may see on the screen of the task communication device 305, in reference to FIGS. 3A-3C. In the example shown, the hustler assigned for this mission is Hustler 777. The information displayed on the screen of the task communication device 305 notifies the driver of Hustler 777 that a container, in this example MSCU9682905, is available for pickup at Crane 1. Accordingly, the driver will drive Hustler 777 to Crane 1 where container MSCU9682905 will be lifted onto Hustler 777's chassis by Crane 1.

FIG. 6 illustrates examples of information displayed by display devices for the mission task of container pickup at vessel in accordance with an embodiment of the invention. More specifically, FIG. 6 shows a number of options of the information corresponding to different aspects of the mission task that can be displayed by the display devices on Hustler 777. From the time the mission appears on Hustler 777's work list until the container is landed on the chassis, Hustler 777's display devices may display one or more of the options shown in diagrams 600(a)-600(d). Such information is provided in the mission information received by the communication device 305 and is displayed automatically without any intervention of the hustler driver. Diagram 600(a) shows a single-container scenario. In this example, the “CR” in “CR1” indicates crane, the “1” in “CR1” indicates the crane number, and “71” indicates the sequence number. In other words, this displayed information communicates to any viewer of the display different aspects of Hustler 777's respective mission task, namely, that Hustler 777 is to pick up a single container at quay Crane 1 which corresponds to the 71^{st} container move in the sequence of containers being discharged by Crane 1. Diagram 600(b) shows a twinned, or double-container scenario, in which Hustler 777 is to pick up two containers from Crane 1 with the discharge sequence numbers being 71 and 72, respectively. In this example, the numbers 71 and 72 correspond to the 71^{st} and 72^{nd} container moves in the sequence of containers being discharged by Crane 1. Diagram 600(c) shows the information that may be displayed by a top-facing display device on Hustler 777 to notify the crane operator the sequence number associated with Hustler 777. Diagram 600(d) shows another display option. As shown here, in a single-container scenario, the information displayed indicates that Hustler 777 is to pick up container MSCU9682905 from Crane 1 with a sequence number 71.

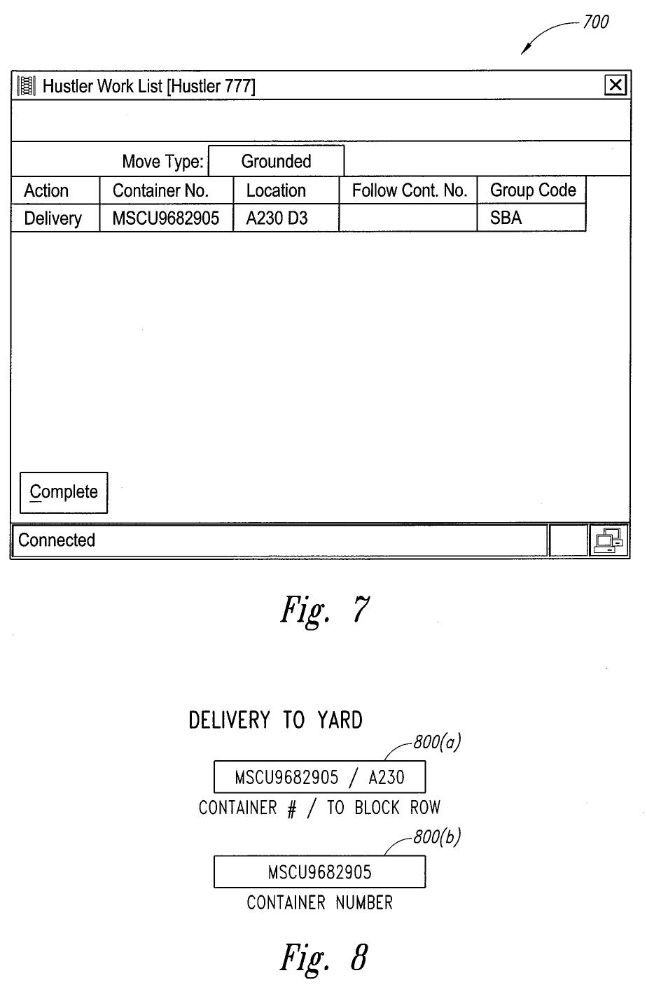

FIG. 7 illustrates a sample screen shot 700 of a mission task received and displayed by the task communication device of Hustler 777 for delivery of the loaded container from vessel to yard in accordance with an embodiment of the invention. Once the system has determined the transfer of container MSCU9682905 from Crane 1 to Hustler 777 to be complete, for example, as previously described, through the use of a trigger event and/or location of the Hustler 777, the task communication device 305 on Hustler 777 will receive new mission information and display the sample screen shot 700. This screen indicates that the driver of Hustler 777 has a delivery to make to Location A230 D3 (i.e., block A, row 230, stack D, tier 3) in the yard.

FIG. 8 illustrates examples of information displayed by display devices during the mission task of delivery of the loaded container from vessel to yard in accordance with an embodiment of the invention. From the time the container MSCU9682905 is loaded onto Hustler 777's chassis until it is lifted off, the display devices on Hustler 777 may display one of the two examples shown. Such information is provided in the mission information received by the communication device 305 and is displayed automatically without any intervention of the hustler driver. Diagram 800(a) shows that the information displayed by the display devices on Hustler 777 may indicate two aspects of the task, including both the container number and the destination (in this example, location A230) where the container is to be delivered. Diagram 800(b) shows that the information displayed on the display devices on Hustler 777 may indicate the aspect of the task as just the container number.

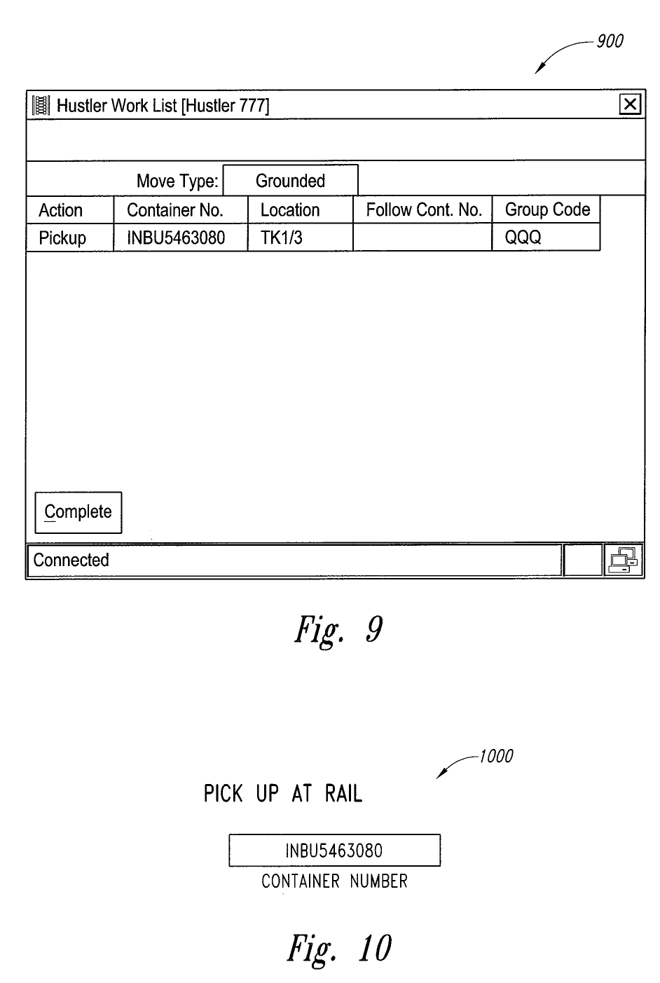

FIGS. 9-12 together depict the missions dispatched and information displayed in a rail discharge scenario. Typically, for rail discharge, a hustler assigned the rail discharge mission is to pick up a container from rail (e.g. cargo train) and deliver the container to the yard for storage or further disposition. FIG. 9 illustrates a sample screen shot 900 of a mission task received and displayed by a task communication device for container pickup at rail in accordance with an embodiment of the invention. More specifically, FIG. 9 shows what a hustler driver may see on the screen of the task communication device 305, in reference to FIGS. 3A-3C. In the example shown, the hustler assigned for this mission is Hustler 777. The information displayed on the screen of the task communication device 305 notifies the driver of Hustler 777 that a container, in this example INBU5463080, is available for pickup at TK1/3 (Track 1, car 3). Accordingly, the driver will drive Hustler 777 to Track 1 where container INBU5463080 will be loaded onto Hustler 777's chassis by a piece of lifting equipment.

FIG. 10 illustrates an example of information displayed by display devices for the mission task of container pickup at rail in accordance with an embodiment of the invention. From the time the mission appears on Hustler 777's work list until the container is loaded onto the chassis, Hustler 777's display devices may display the information shown in diagram 1000. In this example, the container number INBU5463080 is displayed. As previously mentioned, the displayed information is provided in the mission information received by the communication device 305 and is displayed automatically without any intervention of the hustler driver.

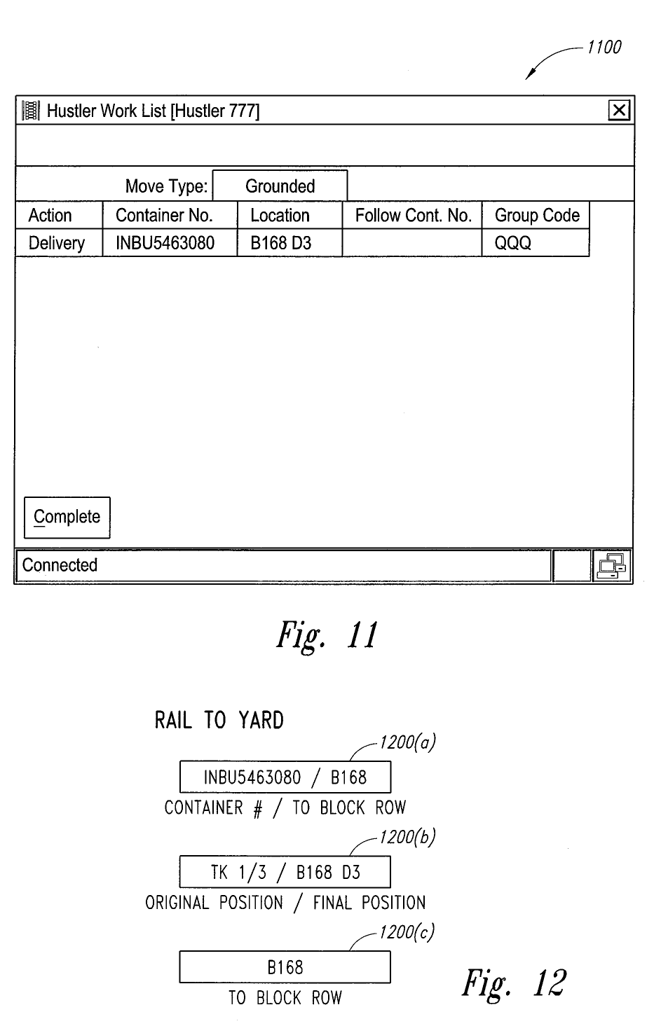

FIG. 11 illustrates a sample screen shot 1100 of a mission task received and displayed by the task communication device of Hustler 777 for delivery of the loaded container from rail to yard in accordance with an embodiment of the invention. Once the system has determined the transfer of container INBU5463080 from rail to Hustler 777 to be complete, the task communication device 305 on Hustler 777 will receive new mission information and display the sample screen shot 1100. This screen indicates to the driver of Hustler 777 that delivery of the container INBU5463080 is to be made to Location B168 D3 (i.e., block B, row 168, stack D, tier 3) in the yard.

FIG. 12 illustrates examples of information displayed by display devices for the mission task of delivery of container from rail to yard in accordance with an embodiment of the invention. From the time the container INBU5463080 is loaded onto Hustler 777's chassis until it is lifted off, the display devices on Hustler 777 may display one of the three examples shown. Again, the displayed information is provided in the mission information received by the communication device 305 and is displayed automatically without any intervention of the hustler driver. In diagram 1200(a), the information displayed indicates two aspects of the task, including the container number, which is INBU5463080 in this example, and the destination, which is B168 (block B, row 168) in this example. Diagram 1200(b) shows that the information displayed indicates two other aspects of the task, including the origin, or where the container was picked up (in this example track 1, car 3), and the destination. Diagram 1200(c) shows that the information displayed may simply indicate the aspect of the task as the destination.

Embodiments of systems and methods for management of transportation equipment at a terminal have been described. It will be appreciated by those ordinarily skilled in the art that the described systems and methods provide an improved approach to notifying terminal personnel of the mission of the transportation equipment. Specifically, using the described systems and methods, the assigned mission for a transportation equipment is first wirelessly transmitted to the task communication system of the transportation equipment and then displayed to both the driver/operator of the transportation equipment and personnel outside the transportation equipment. Furthermore, the information displayed is automatically updated when the system detects completion of a task of the mission, for example, to indicate the next task of the mission.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A system for management of port terminal operations, comprising:
a plurality of task communication devices each associated with a respective one of a plurality of transportation equipment, each task communication device operable to receive a signal indicative of at least one task to be completed by the respective one of the transportation equipment;
a plurality of first display devices, each of the plurality of first display devices coupled to a respective one of the task communication devices and operable to display a first aspect of the at least one task;
a plurality of second display devices, each of the plurality of second display devices coupled to a respective one of the task communication devices and operable to display a second aspect of the at least one task; and
a task dispatch system operable to cause signals each of which indicative of at least one task to be completed by a respective one of the transportation equipment to be transmitted to the plurality of task communication devices.

2. The system of claim 1 wherein the task dispatch system is further operable to detect completion of each of the at least one task with respect to each of the transportation equipment.

3. The system of claim 2 wherein detecting completion of each task comprises detecting a respective triggering event indicative of completion of each task and detecting that the one of the transportation equipment that completed the one task is within an approximate range of an expected location.

4. The system of claim 2 wherein, upon detecting completion of a first task by one of the transportation equipment, the task dispatch system is further operable to cause a signal indicative of a second task to be transmitted to the one of the transportation equipment.

5. The system of claim 1 wherein each of the first display devices and each of the second display devices are mounted on the respective one of the transportation equipment such that information displayed by the first display device is visible to a viewer at ground level and information displayed by the second display device is visible to a viewer at an elevated position higher than the respective one of the transportation equipment.

6. The system of claim 1 wherein the first display device is further operable to concurrently display the first aspect and at least a third aspect of the respective at least one task.

7. The system of claim 1, further comprising a plurality of third display devices, wherein each of the plurality of third display devices is coupled to a respective one of the task communication devices and operable to display at least the first aspect of the at least one task to be completed by the respective one of the transportation equipment.

8. The system of claim 7 wherein each of the first, second and third display devices are mounted on the top of a driver cab of the respective one of the transportation devices such that the first display device is facing one side of the respective one of the transportation devices at a respective angle toward the front, the third display device is facing the other side of the respective one of the transportation devices at a respective angle toward the front, and the second display device is facing upward.

9. The system of claim 1 wherein at least one of the first and second display devices comprises a light-emitting diode (“LED”) display device.

10. A system for visually displaying information of mission for a plurality of transportation equipment, comprising:
a plurality of mobile communication units each associated with a respective one of the plurality of transportation equipment, each of the plurality of mobile communication units operable to receive respective electronic signals indicative of a respective assignment for the respective one of the transportation equipment, each of the plurality of mobile communication units operable to cause a message indicative of at least one task of the respective assignment to be displayed to personnel situated outside the one of the respective transportation equipment and become aware of the respective assignment by viewing the displayed message; and
a central communication system operable to gather data to cause the respective electronic signals to be transmitted to each of the plurality of mobile communication units.

11. The system of claim 10 wherein the central communication system is further operable to detect completion of the at least one task of the respective assignment by the respective one of the transportation equipment.

12. The system of claim 11 wherein the central communication system is further operable to detect completion of at least one task of the respective assignment by the respective one of the transportation equipment comprises the central communication system further operable to detect a respective trigger event related to the task.

13. The system of claim 11 wherein the central communication system is further operable to cause respective electronic signal indicative of a new assignment to be transmitted to the respective mobile communication unit associated with the one of the respective transportation equipment upon detecting completion of the respective assignment.

14. The system of claim 11 wherein the central communication system is operable to cause electronic signal indicative of a number of assignments for one of the transportation equipment to be transmitted to the respective mobile communication unit, and wherein the central communication system is further operable to cause the respective mobile communication unit to display a message indicative of a second of the number of assignments upon detecting completion of a first of the number of assignments.

15. The system of claim 10, further comprising a plurality of display units each mounted on a respective one of the transportation equipment, each of the plurality of display units including:
a first display operable to display the message indicative of at least the first aspect of the respective assignment;
a second display operable to display the message indicative of at least the first aspect of the respective assignment; and
a third display operable to display a second message indicative of a second aspect of the respective assignment, wherein the first, second and third displays each faces a different angle so that the messages displayed can be viewed from different angles in relation to the respective one of the transportation equipment.

16. A mission display system for a transportation equipment at a port terminal, comprising:
at least one display device operable to display messages, the at least one display device being mounted on the transportation equipment and configured to display messages visible to at least some personnel outside the transportation equipment; and
a communication device coupled to the at least one display device, the communication device operable to receive electronic data indicative of a mission to be carried out by the transportation equipment, the communication device operable to cause the at least one display device to display at least one message indicative of at least one aspect of the mission.

17. The system of claim 16 wherein the at least one display device comprises a first, second, and third display devices, the first display device mounted on top of a driver cab of the transportation equipment facing a first direction relative to the transportation equipment, the second display device mounted on top of the driver cab of the transportation equipment facing a second direction relative the transportation equipment, the second direction different than the first direction, and the third display device mounted on top of the driver cab of the transportation equipment facing upward.

18. The system of claim 16, further comprising a mission dispatch system, the mission dispatch system operable to determine the mission of the transportation equipment and cause the electronic data indicative of the mission to be transmitted to the communication device.

19. The system of claim 16 wherein at least one of the first and second display devices comprises a light-emitting diode (“LED”) display device.

20. A method of providing visual display of missions of a transportation equipment, comprising:
determining tasks to be undertaken by the transportation equipment;
displaying at least one message indicative of a respective current task of the tasks when the respective current task is being undertaken, the at least one message visible to personnel outside the transportation equipment
detecting completion of the respective current task; and
displaying at least one message indicative of a respective subsequent task of the tasks after detecting completion of the respective current task.

21. The method of claim 20 wherein displaying at least one message indicative of a respective current task of the tasks comprises displaying a first message indicative of a first aspect of the respective current task that is visible to personnel outside the transportation equipment from the first set of angles and displaying a second message indicative of a second aspect of the respective current task that is visible to personnel outside the transportation equipment from a second set of angles different from the first set of angles.

22. The method of claim 21 wherein detecting completion of the respective current task comprises detecting at least a respective triggering event indicative of completion of the respective current task.

23. A method of visual notification of missions of a plurality of transportation equipment, comprising:
scheduling respective missions of each of the transportation equipment;
disseminating information indicative of the respective missions to an operator of each of the transportation equipment;
when first task of a mission of the respective missions of one of the transportation equipment is being carried out, causing a first message indicative of the first task to be displayed from the one of the transportation equipment so that the first message is visible to a first group of viewers on one side of the one of the transportation equipment and visible to a second group of viewers on the other side of the one of the transportation equipment; and
when the first task is complete, causing a second message indicative of a second task of the mission of the one of the transportation equipment to be displayed from the one of the transportation equipment, the second task scheduled to be carried out after the first task.

24. The method of claim 23, further comprising detecting at least a triggering event indicative of completion of the first mission.

25. The method of claim 23, further comprising causing a third message indicative of the first mission to be displayed from the one of the transportation equipment in a way that the third message is visible to a viewer at an elevated position higher than the one of the transportation equipment.
